(19) United States
(12) Patent Application Publication
(10) Pub. No.: US 2007/0135175 A1
(43) Pub. Date: Jun. 14, 2007

(54) Handsfree system

(75) Inventor: Naoki Matsuda, Anjo-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Aichi-pref. (JP)

(21) Appl. No.: 11/637,843

(22) Filed: Dec. 12, 2006

(30) Foreign Application Priority Data
Dec. 12, 2005 (JP) 2005-357653

(51) Int. Cl. H04M 1/00

(52) U.S. Cl. 455/569.1

(57) ABSTRACT

A handsfree apparatus continues disruption of a handsfree profile connection operation when a control unit detects a handset call in operation, and displays a screen that allows a user to choose one of a permission option and a rejection option of the handsfree profile connection operation for having a user input without terminating the handset call.

### CROSS REFERENCE TO RELATED APPLICATION

This application is based on and claims the benefit of priority of Japanese Patent Application No. 2005-357653 filed on Dec. 12, 2005, the disclosure of which is incorporated herein by reference.

### FIELD OF THE INVENTION

The present invention generally relates to a handsfree system for use in a vehicle.

### BACKGROUND INFORMATION

In recent years, a handsfree system on a vehicle with a Bluetooth communication function (Registered trademark) is available for a handsfree call with a cellular phone when a vehicle system switch (ACC switch) is turned on with the following conditions. That is, when a Bluetooth cellular phone is receiving a handset call (i.e., receiving a call through a handset instead of receiving a call as the handsfree call through the handsfree system) and the Bluetooth communication function is available for a communication between the handsfree system and the Buletooth cellular phone, the handsfree call by the handsfree system is provided upon having an additional condition that a call switch operation for switching the handset call to the handsfree call on either of the Bluetooth cellular phone or the handsfree system on the vehicle is conducted by the user (Refer to, for exaple, Japanese patent document JP-A-2002-171337).

The handsfree call operation scheme described above operates the handsfree system and the Bluetooth cellular phone according to the following procedure. That is, as shown in FIGS. 5 and 6, the handsfree system sends a communication start request by using a handsfree profile (HFP: a communication protocol of the Bluetooth standard) to the Bluetooth cellular phone (step S505/S605) after the system is turned on (step S500/S600), and sends a phone status request to the Bluetooth cellular phone (step S510/S610) for having a phone status acknowledgement in return from the Bluetooth cellular phone (step S515/S615).

The handsfree system sets the phone status acknowledgement from the Bluetooth cellular phone having a status change to the Bluetooth cellular phone (step S520/S620) when the acknowledgement is received, and waits for an acknowledgement setting result of the status change from Bluetooth cellular phone. Then, the handsfree system connects to the Bluetooth cellular phone based on the HFP (step S530/S630) when the handsfree system receives the acknowledgement setting result of the status change from Bluetooth cellular phone in return (step S525/S625).

Then, the Bluetooth cellular phone establishes a voice link with the handsfree system based on the HFP (step S535/S635). The handsfree system displays a screen that allows a user to choose from a permission or a rejection of the handsfree operation (step S540/S640) when the voice link is established. The handsfree system starts the handsfree call when the user chooses the permission of the handsfree operation (step S545: YES) after erasing the screen (step S550). That is, the handsfree system is switched to a handsfree call condition (step S555).

However, the procedure described above has a problem. That is, the Bluetooth cellular phone in the above procedure suffers from a silence period (no sound period) when the user chooses the permission of the handsfree operation (step S545: YES) after the establishment of the voice link (step S535) due to a configuration of the Bluetooth cellular phone that terminates the handset call when the voice link is being established with the handsfree system as shown in FIG. 5. More practically, when the user selects the permission of the handsfree call operation (step S545: YES) after the establishment of the vice link with the Bluetooth cellular phone (step S535), the user experiences the silence period until the handsfree call is actually available (step S555). Similarly, when the user selects the rejection of the handsfree call operation (step S645: YES), the user also experience the silence period until the user terminates the handset call (step S655) as shown in FIG. 6.

### SUMMARY OF THE INVENTION

In view of the above-described and other problems, the present disclosure provides a handsfree system that improves its usability by preventing a silence period when a user chooses one of two alternative options of a permission or a rejection of a handsfree operation with a cellular phone.

In one aspect of the present disclosure, the handsfree apparatus in association with a cellular phone that externally notifies a self operation status in response to a request for a connection from an external device based on a handsfree profile includes a short range communication device that is being connectable with the cellular phone based on the handsfree profile, an option determination unit for allowing a user to choose from a permission option and a rejection option of a connection operation based on the handsfree profile, a notification unit for notifying the connection operation for the user, and a control unit for the connection operation. The control unit maintains a handset call by disrupting the connection operation based on the handsfree profile between the short range communication device and the cellular phone when the control unit detects the operation status of the cellular phone being derived in response to the request for the connection to the cellular phone based on the handsfree profile as the handset call of the cellular phone in operation, and the control unit simultaneously operates the notification unit for having an input of one of the permission option and the rejection option of the connection operation based on the handsfree profile from the option determination unit that is controlled by user. Further, the control unit simultaneously waits the selection of one of the permission option and the rejection option of the connection operation. In this manner, the handsfree apparatus of the present disclosure allows the user to choose from one of the permission option and the rejection option of the connection while the user is being involved in the handset call. Therefore, the usability of the handsfree apparatus is improved by preventing a silence period caused by choosing one of the two options of the handsfree operation.

In another aspect of the present disclosure, the control unit of the handsfree apparatus immediately executes the connection operation based on the handsfree profile when the user chooses the permission option of the connection operation based on the handsfree proficle by the option determination unit. In this manner, the handset call is switched to the handsfree call without having the silence period.

In yet another aspect of the present disclosure, the control unit of the handsfree apparatus is configured to maintain the handset call by continuing disruption of the connection operation based on the handsfree profile when the cellular phone is involved in the handset call. In this manner, the handset call does not suffers from the silence period.

In still yet another aspect of the present disclosure, the control unit of the handsfree apparatus is configured to executes the connection operation based on the handsfree profile when the cellular phone terminates the handset call. In this manner, a subsequent call is appropriately handled.

The above described features regarding the handsfree call may also be implemented by a handsfree system that includes the above-described handsfree apparatus and the cellular phone.

### BRIEF DESCRIPTION OF THE DRAWINGS

Other objects, features and advantages of the present invention will become more apparent from the following detailed description made with reference to the accompanying drawings, in which:

FIG. 1 shows a block diagram of a handsfree system in an embodiment of the present disclosure;

FIG. 2 shows a sequence diagram of a system operation in the embodiment;

FIG. 3 shows another sequence diagram of the system operation in the embodiment;

FIG. 4 shows yet another sequence diagram of the system operation in the embodiment;

FIG. 5 shows a sequence diagram of the system operation of a conventional handsfree system; and

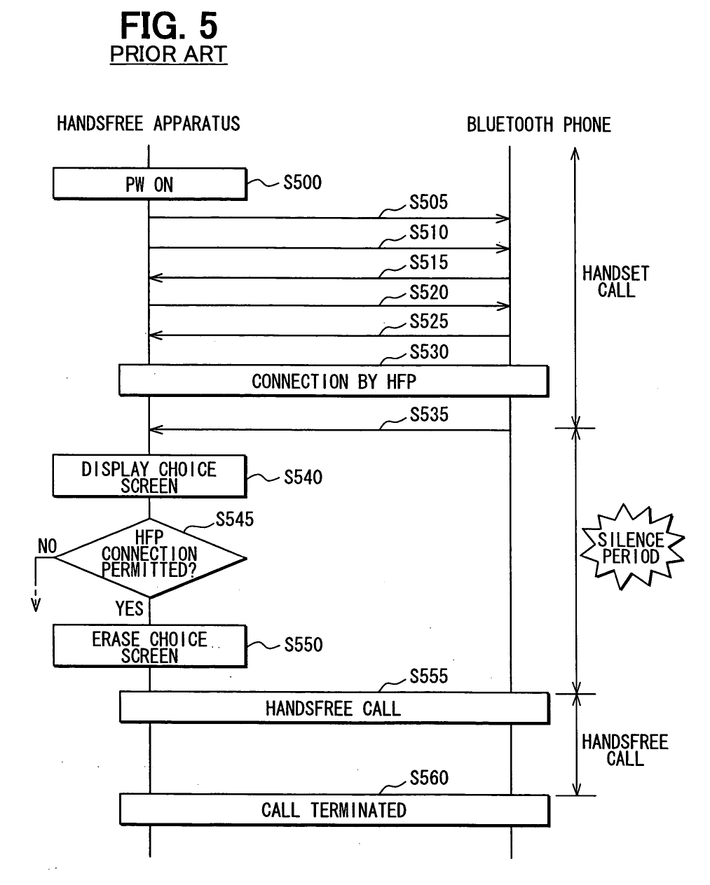

FIG. 6 shows another sequence diagram of the system operation of the conventional handsfree system.

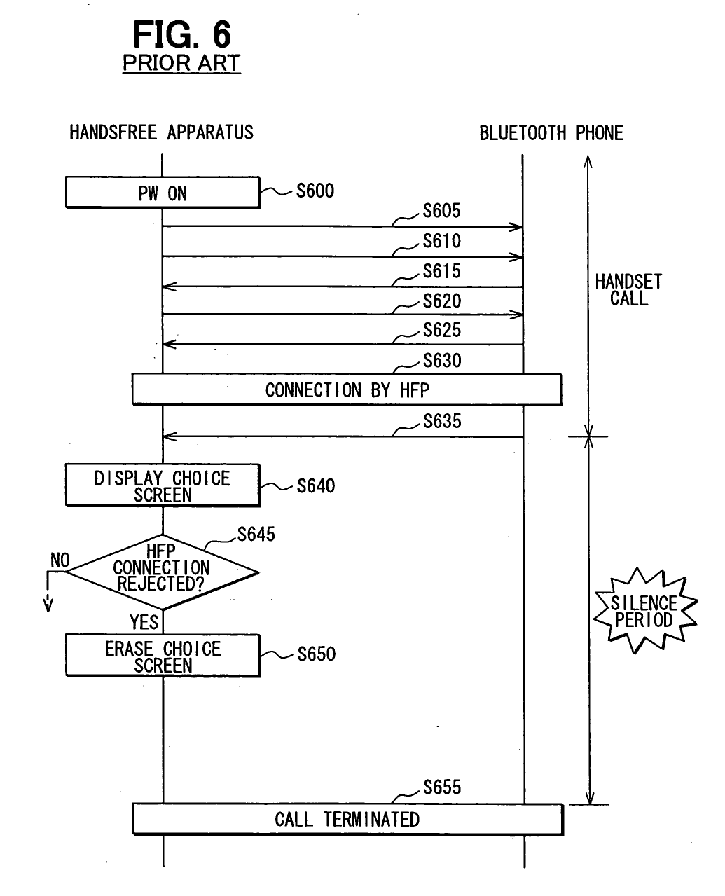

### DETAILED DESCRIPTION

Embodiments of the present invention are described with reference to the drawings. Like parts have like numbers in each of the embodiments.

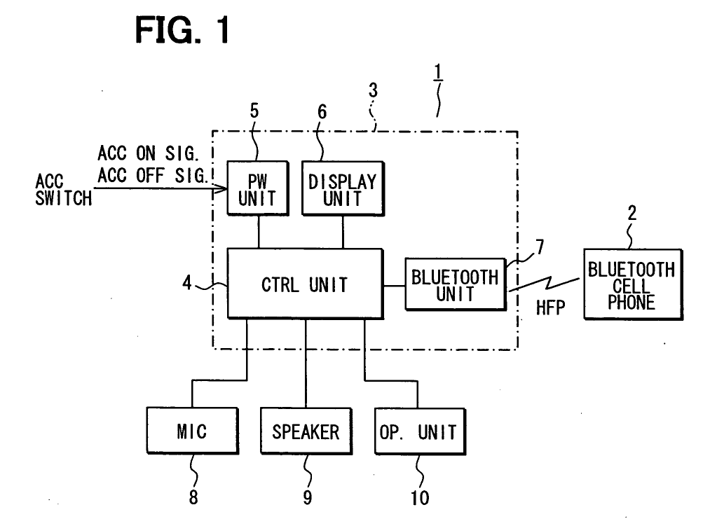

One of preferred embodiments of the present disclosure is described with reference to FIGS. 1 to 4. FIG. 1 shows a block diagram of a handsfree system 1 for use in a vehicle in an embodiment of the present disclosure. The handsfree system 1 includes Bluetooth cellular phone 2 having Bluetooth function and a handsfree apparatus 3 having Bluetooth function. The cellular phone 2 and the handsfree apparatus 3 are communicable with each other by using Bluetooth function. Further, the cellular phone 2 is communicable with another cellular phone and/or a lind-line phone through the telephone network in addition to have Bluetooth communication with the handsfree apparatus 3 when power supply for the cellular phone 2 and the handsfree apparatus 3 is turned on and the cellular phone 2 is within a range of communication.

The handsfree apparatus 3 includes a control unit 4, a power control unit 5, a display unit 6, and Bluetooth unit 7. The control unit 4 includes a CPU, a RAM, a ROM and the like for executing a control program that controls overall operations of the handsfree apparatus 3.

The power control unit 5 receives ACC ON and OFF signals from an ACC switch when the ACC switch is turned on and off. The power control unit 5 allows a power supply for the control unit 4 to activate an entire handsfree apparatus 3 when the ACC ON signal is inputted thereto, and prohibits the power supply for the control unit 4 to stall the entire handsfree system 1 when the ACC OFF signal is inputted thereto. In addition, the power control unit 5 watches an input of the ACC ON signal by maintaining operation on a fraction of power supply even when the handsfree apparatus 3 is in a turnoff state.

The display unit 6 executes a display operation according to a display instruction signal when the display instruction signal is inputted thereto. The Bluetooth unit 7 executes a Bluetooth communication operation according to an operation instruction signal from the control unit 4 when the operation instruction signal is inputted thereto. In this case, the Bluetooth unit 7 uses a handsfree profile (HFP) as a communication protocol between the Bluetooth cellular phone 2 and the control unit 4. In addition, the Bluetooth unit 7 may also use a dialup network protocol (DUNP) for a data communication process by, for example, the control unit 4 that is in association with the Bluetooth cellular phone 2.

The control unit 4 transfers a voice received by the microphone 8 of the handsfree apparatus 3 from the Bluetooth unit 7 to the cellular phone 2, and outputs a voice that is transferred from the cellular phone 2 to the Bluetooth unit 7 by using the speaker 9 when the Bluetooth unit 7 is using the HFP. Further, the control unit 4 executes an operation according to an operation signal from an operation unit 10 when the operation signal that represents a user operation is inputted thereto. In this case, the operation unit 10 may be a mechanical switch for mechanical operation or a touch switch on the display unit 6 for touch operation.

The handsfree apparatus 3 may be disposed as a part of a navigation system on the vehicle (not shown in the figure) for the Bluetooth communication between the navigation system and the Bluetooth cellular phone.

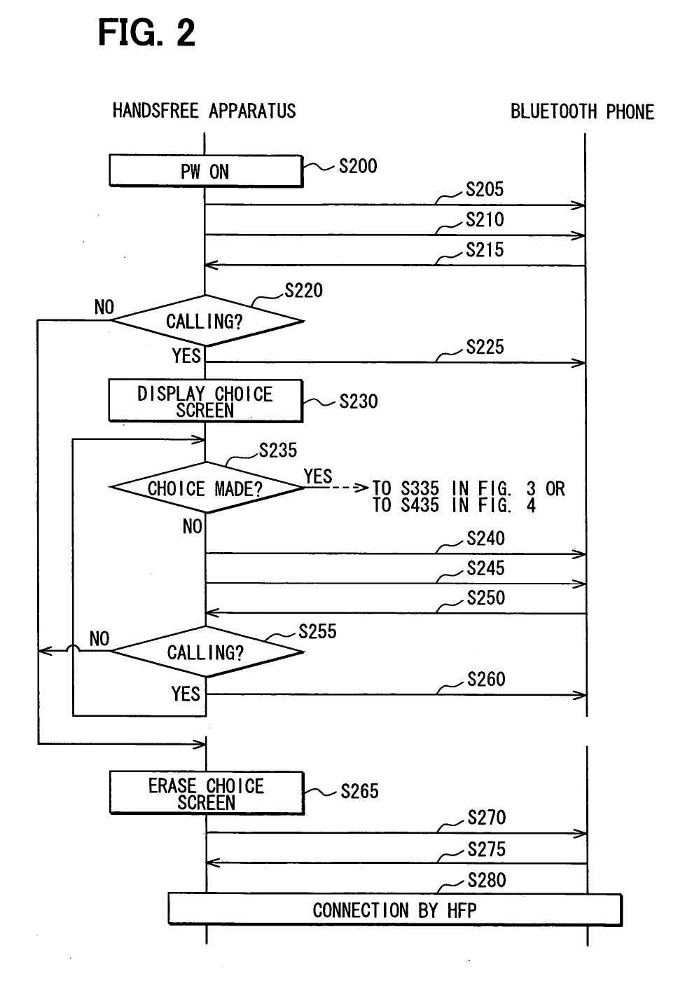

The operation of the handsfree apparatus 3 in association with the Bluetooth cellular phone 2 is described with reference to sequence diagrams in FIGS. 2 to 4.

The operation of the handsfree apparatus 3 starts when the ACC ON signal is inputted to the power control unit 5 (step S200). Then, the control unit 4 sends a request for a HFP connection (i.e., a connection between the cellular phone 2 and the apparatus 3 based on the handsfree profile of the Bluetooth standard) to the cellular phone 2 when the apparatus 3 is turned on (step S205). Then, the control unit 4 sends a request for an operation status of the Bluetooth cellular phone 2 (step S210). Then, the control unit 4 waits an acknowledgement of the operation status of the cellular phone 2 such as a calling status, a waiting status, or the like in response to the request. Then, the control unit 4 receives the acknowledgement of the operation status from the cellular phone 2 (step S215). Then, the control unit 4 determines whether the cellular phone 2 is involved in a handset call by using a microphone and a speaker installed therein based on an acknowledged operation status of the cellular phone 2 (step S220).

Then, the control unit 4 sends a request for a disruption of a HFP connection (i.e., a connection established by using the handfree profile) (step S225) when the cellular phone 2 is determined to be involved in the handset call (step S220: YES). The request for the disruption of the HFP connection from the control unit 4 makes the cellular phone 2 send a connection disruption command that is defined in the Bluetooth standard. Then, the control unit 4 displays a screen on the display unit 6 for allowing a user to choose one of permission or rejection of a handsfree operation (step S230). In this manner, the user can make a choice for either permitting or rejecting the handsfree operation of the cellular phone 2.

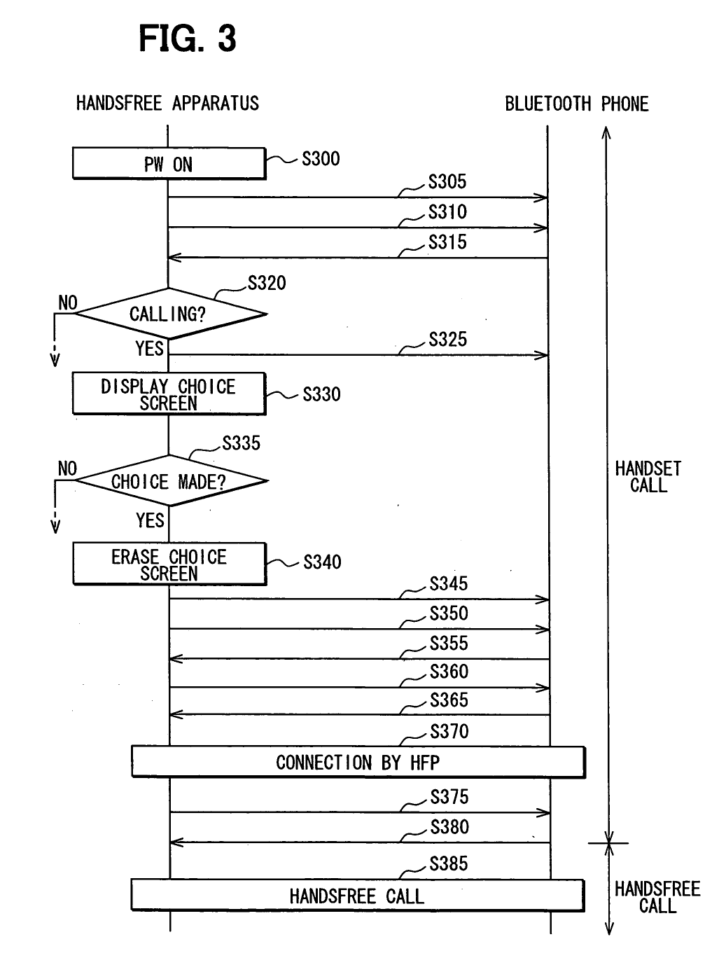

When the user chooses the permission of the handsfree operation (step S235/S335), the control unit 4 erases the screen that is displayed for a user's choice of the handsfree operation (step S340), and sends a request for the HFP connection to the cellular phone 2 again (step S345) as shown in FIG. 3. Then, the control unit 4 sends a request for the operation status of the cellular phone 2 and waits the acknowledgement of the operation status of the cellular phone 2 (steps S350).

Then, the control unit 4 receives the acknowledgement of the operation status of the cellular phone 2 (step S355), and sends a setting request for setting a status change to the cellular phone 2 without examining the received acknowledgement (step S360). Then, the control unit 4 waits a setting result acknowledgement in response to the setting request. Then, the control unit 4 establishes a connection to the cellular phone 2 based on the HFP (step S370) when the control unit 4 receives the setting result acknowledgement from the cellular phone 2 (step S365). Then, the control unit 4 sends a request for a voice link connection to the cellular phone 2 (step S375) after establishing the connection by using the HFP (step S370). When the voice link connection to the cellular phone 2 is established (step S380), a handsfree call is put into effect, that is, the Bluetooth cellular phone 2 and the handsfree apparatus 3 are engaged in a handsfree call condition (step S385).

In the procedure described above with reference to the sequence diagram, the user can determine whether he/she permits or rejects the handsfree operation without disconnecting the handset call. Therefore, the user can quickly switch from the handset call to the handsfree call without having a silence period in a switching operation when the permission of the handsfree operation is selected.

On the other hand, when the user chooses the rejection of the handsfree operation (step S435), the control unit 4 erases the screen that is displayed for the user's choice of the handsfree operation (step S440), and sends a request for the HFP connection to the cellular phone 2 (step S445). Then, the control unit 4 sends a request for the operation status to the cellular phone 2 for having the acknowledgement in response (step S450).

The control unit 4 determines whether the cellular phone 2 is being involved in the handset call based on the acknowledgement of the operation status when the control unit 4 receives the acknowledgement from the cellular phone 2 (step S455). Then, the control unit 4 sends a request for HFP connection disruption to the cellular phone 2 (step S465) when the cellular phone 2 is determined to be involved in the handset call (step 460: YES). Then, the control unit 4 sends a request for HFP connection to the cellular phone 2 again (step S445). The control unit 4 keeps sending the request for the HFP connection until it detects a termination of the handset call of the cellular phone 2 (step S460: NO).

When the control unit 4 detects that the cellular phone 2 is not involved in the handset call or that the handset call of the cellular phone 2 is terminated (step S460: NO), the control unit 4 sends a setting request for setting a status change to the cellular phone 2 (step S470), and waits a setting result acknowledgement in response to the setting request. Then, the control unit 4 establishes a connection to the cellular phone 2 based on the HFP (step S480) when the control unit 4 receives the setting result acknowledgement from the cellular phone 2 (step S475).

When the cellular phone 2 is determined not to be involved in the handset call (step S220: NO), the control unit 4 takes a series of steps S265 to S280 as steps S340, S360, S365, and S370 for establishing the HFP connection.

In addition, the steps S470 to S480 are identical with the steps S270 to S280 that are taken after the step S220 when the cellular phone 2 is determined not to be involved in the handset call with an exception that the step S270 is preceded by step S265 for erasing the choice screen. Further, steps S300 to S330 and steps S400 to S430 are identical to steps S200 to S230 that basically initializes the Bluetooth connection between the cellular phone 2 and the handsfree apparatus 3.

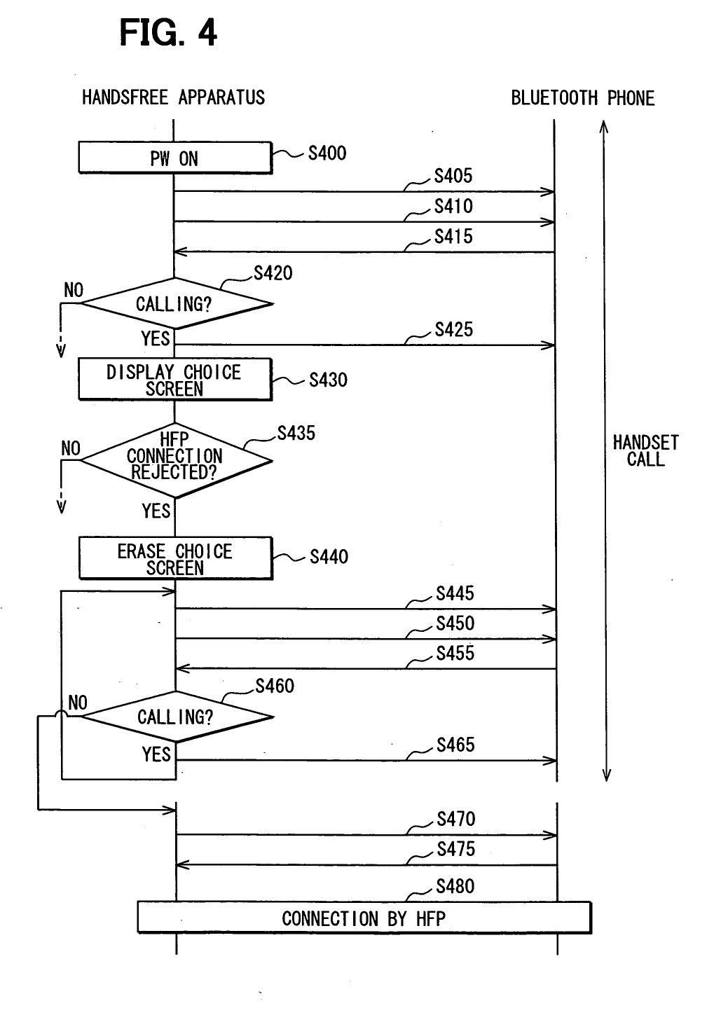

In the procedure described above with reference to the sequence diagram in FIG. 4, the user can continue the handset call without having the silence period in the call when the user chooses to reject the handsfree operation. In addition, the HFP connection to the cellular phone 2 can be quickly established when the user terminates the handset call. Therefore, the handsfree operation for a subsequent call can appropriately be enabled between the cellular phone 2 and the handsfree apparatus 3.

The procedures described above uses the connection disruption command defined in the Bluetooth standard for disrupting the HFP handsfree connection to the cellular phone 2. However, the HFP handsfree connection may be disrupted by not setting the status change to the Bluetooth cellular phone 2 after the of the operation status of the cellular phone 2 is acknowledged.

The advantage of the present embodiment is summarized in the following manner. That is, when the Bluetooth cellular phone 2 is involved in the handset call, the connection operation between the Bluetoothe unit 7 and the Bluetooth cellular phone 2 based on the handsfree profile is disrupted for continuing the handset call, and the user's choice for either permitting or rejecting the HFP connection operation is allowed with the display of the HFP connection operation choice screen. In this manner, the silence period in the call at a time of the user's choice of the HFP connection operation is prevented for an improved convenience for the user.

In addition, the permission of the HFP connection operation by the user configured to be immediately followed by the HFP connection operation enables a quick and smooth transition from the handset call to the handsfree call without having the silence period.

Further, the rejection of the HFP connection operation by the user is configured to be followed by a continued disruption of the HFP connection operation for maintaining the handset call when the cellular phone 2 is detected to be involved in the handset call. Therefore, the silence period in the handset call with the cellular phone 2 is prevented. In this case, the termination of the handset call is configured to be immediately followed by the HFP connection operation. Therefore, the handsfree call for a subsequent call by the cellular phone 2 is appropriately enabled.

Although the present invention has been fully described in connection with the preferred embodiment thereof with reference to the accompanying drawings, it is to be noted that various changes and modifications will become apparent to those skilled in the art.

For example, a power supply for the handsfree apparatus 3 may be started when, for example, a power supply start button on the handsfree apparatus 3 is operated.

Further, the HFP connection operation choice screen may be displayed on top of a navigation screen when the handsfree apparatus 3 is a part of the navigation system. Furthermore, the choice of the handsfree operation by the user may vocally be provided for the user. A voice guidance for allowing the user's choice may be accompanied by the choice screen on the display unit 6.

Such changes and modifications are to be understood as being within the scope of the present invention as defined by the appended claims.

What is claimed is:

1. A handsfree apparatus in association with a cellular phone that externally notifies an operation status of the cellular phone in response to a request for a connection from an external device based on a handsfree profile, the handsfree apparatus for use in a vehicle comprising:
a short range communication device that is being connectable with the cellular phone based on the handsfree profile;
an option determination unit for allowing a user to choose one of a permission option and a rejection option of a connection operation based on the handsfree profile;
a notification unit for notifying the connection operation for the user; and
a control unit for the connection operation,
wherein the control unit maintains a handset call by disrupting the connection operation based on the handsfree profile between the short range communication device and the cellular phone when the control unit detects the operation status of the cellular phone being derived from the cellular phone in response to the request for the connection to the cellular phone based on the handsfree profile as the handset call of the cellular phone in operation,
the control unit simultaneously operates the notification unit for having an input of one of the permission option and the rejection option of the connection operation based on the handsfree profile from the option determination unit that is controlled by the user, and
the control unit simultaneously waits the selection of one of the permission option and the rejection option of the connection operation.

2. The handsfree apparatus as in claim 1,
wherein the control unit immediately executes the connection operation based on the handsfree profile when the user chooses the permission option of the connection operation based on the handsfree profile by using the option determination unit.

3. The handsfree apparatus as in claim 1,
wherein, while the operation status of the cellular phone is recognized as the handset call in operation based on a notification of the operation status from the cellular phone, the control unit maintains the handset call by continuing disruption of the connection operation based on the handsfree profile.

4. The handsfree apparatus as in claim 3,
wherein the control unit immediately executes the connection operation based on the handsfree profile when the cellular phone terminates the handset call.

5. A system in a vehicle having a handsfree apparatus in association with a cellular phone that externally notifies an operation status of the cellular phone in response to a request for a connection from an external device based on a handsfree profile, the system comprising:
a short range communication device that is being connectable with the cellular phone based on the handsfree profile;
an option determination unit for allowing a user to choose one of a permission option and a rejection option of a connection operation based on the handsfree profile;
a notification unit for notifying the connection operation for the user; and
a control unit for the connection operation,
wherein the control unit maintains a handset call by disrupting the connection operation based on the handsfree profile between the short range communication device and the cellular phone when the control unit detects the operation status of the cellular phone being derived from the cellular phone in response to the request for the connection to the cellular phone based on the handsfree profile as the handset call of the cellular phone in operation,
the control unit simultaneously operates the notification unit for having the selection of one of the permission option and the rejection option of the connection operation based on the handsfree profile with the option determination unit by the user, and
the control unit simultaneously waits the selection of one of the permission option and the rejection option.
